(19) United States
(12) Patent Application Publication
(10) Pub. No.: US 2008/0202855 A1
(43) Pub. Date: Aug. 28, 2008

(54) Push Car

(76) Inventor: Gichun Kim, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 11/995,368

(22) PCT Filed: Jul. 6, 2006
(86) PCT No.: PCT/KR2006/002646

§ 371 Date: Jan. 11, 2008

(30) Foreign Application Priority Data
Jul. 12, 2005 (KR) 10-2005-0062992
Jul. 3, 2006 (KR) 10-2006-0061740

(51) Int. Cl. F03G 5/00

(52) U.S. Cl. 185/2

(57) ABSTRACT

The present invention regards to a push car to push a parked car. The push car push the parked car effectively because the rotation direction of its rollers contacted on the earth surface is opposite to that of its another rollers contacted on the wheel of the car.

### TECHNICAL FIELD

We often push a parked car to move it.

In case of pushing the parked car by our own efforts, just a little help makes even easier to push. The present invention regards to a push car locating between earth surface and wheel of a car, pushing the car and revolving the wheel of the car.

### BACKGROUND ART

To move a parked car we use a wrecker or push the parked car by our own efforts. It is not efficient to use a wrecker to move a parked car a short distance. And it is a job of work to push the parked car by our own efforts .

### DISCLOSURE OF INVENTION

### Technical Problem

When a parked car must be move a short distance, a small and carry-along vechicle to push the parked car is useful. If the vechicle is so small, it cannot reach the bumper of the parked car from the earth surface. And it may be push the only wheel instead of the bumper of the parked car. But when the vechicle push the wheel of the parked car, the wheel cannot revolve easely due to friction between the vechicle and the wheel of the parked car.

### Technical Solution

Therefore it is necessary to get rid of friction between the vechicle and the wheel of the parked car. Furthermore it is better if the friction force can revolve the wheel of the parked car in the direction of advance. It is possible if a push car has at least one roller not to contact with the earth surface but to contact with the wheel of the parked car

### Advantageous Effects

The push car can save a pusher's effort when he push the parked car.

### BRIEF DESCRIPTION OF THE DRAWINGS

FIG. 1 is a cross-sectional view of the push car and the wheel of the parked car.

FIG. 2 is a diagram representing external forces exerting on the wheel of the parked car.

### BEST MODE FOR CARRYING OUT THE INVENTION

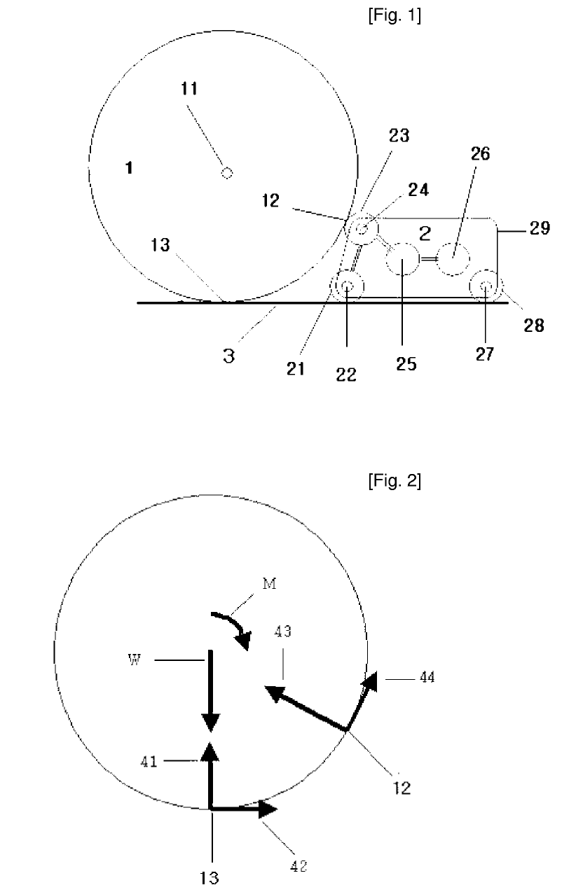

Hereinafter I explain the present invention with reference to drawings. FIG. 1 is an idealized cross-sectional view of the push car and the wheel of the parked car which contact each other. FIG. 2 is a diagram representing external forces exerting on the wheel of the parked car. In the figure the wheel (1) is one of the wheels of the parked car. The push car (2) is comprised of a front roller (21), a upper roller (23), a decelerator (25), a power source (26), a rear roller (28) and a housing (29).

Wheel (1) comes in contact with the earth surface on the first contact point (13) and with the upper roller (23) of the push car on the second contact point. The wheel (1) bears up the weight of the parked car through the bearing between the axis of the car and the wheel of the car, and receives reaction force and friction force from the earth surface. If the moment of external forces exerting on the wheel is larger than that of maximum static friction moment between the axis and the bearing of the parked car, the wheel revolves.

Front roller (21) of the push car is a cylindrical object revolving on its axis (22). The front roller (21) comes in contact with earth surface but is out of contact with the wheel (1) of the parked car. If the front roller (21) revolves counterclockwise direction on its axis (22), the push car (2) tends to move in left direction in the FIG. 1 by the friction force between the front roller (21) and the earth surface (3). This friction force between the front roller and the earth surface induce the second reaction force (43) on the second contact point (12). The rotation of the front roller (21) is due to the rotational force from the upper roller (23). In FIG. 2 two solid connecting lines between the front roller (21) and the upper roller (23) represent the transmission pathway of rotational power. In this case the rotational direction of the upper roller is opposite to the direction of the front roller.

Upper roller (23) of the push car is a cylindrical object revolving on its axis (24). The upper roller (23) is out of contact with the earth surface (3) but comes in contact with the wheel (2) of the parked car. To contact with the wheel (1) a part of the upper roller (23) must be protruded outside of the housing (29). The axis of the upper roller (24) is parallel to that of the front roller (22). If the upper roller (23) revolves in clockwise direction, the front roller (21) is revolved in counterclockwise direction and the wheel (1) of the parked car is revolved in counterclockwise direction by the friction force (44) between the upper roller and the wheel. For not slipping between the front roller (21) and the earth surface, and between the wheel (1) and the upper roller (23), angular velocity times radius of the front roller (21) must be equal to angular velocity times radius of the upper roller (23). For the mechanical stability of the push car, it is advantageous that the upper roller (23) of the push car locates more behind than the front roller of the push car. The upper roller (23) is revolved by the decelerator (25).

Decelerator (25) plays a role to decrease rotational velocity and to increase rotational force. And the decelerator (25) transmits the rotational force from the power source (26) to the upper roller (23) of the push car.

Power source (26) generates rotational force using electricity or force of restitution of spring. In case using electricity there are various ways: using a vehicle battery or a dry cell. Rotational force generated in the power source (26) is transmitted to the decelerator (25). The power source (26) may include a controller to supply or cut off electricity to power source or to change the direction of rotational power of power source reciprocally (not shown). Also the controller may include a receiver receiving signal from outside remote controller.

Housing (29) supports the axis (22) of the front roller and the axis (24) of the upper roller, and surrounds the decelerator (25) and the power source (26).

Hereinafter I explain operation process of the push car represented in the present invention. When we want to move a parked car, we locate the push car in a straight line to the wheel so as to its upper roller contacted with the wheel and its front roller and rear roller (28) contacted with the earth surface. And we operate the power source. Then the power source of the push car generates rotating force and the rotating force is transmitted to the decelerator. The decelerator increase rotational force from the power source and transmits the enforced rotational force to the upper roller of the push car. The upper roller transmits the rotational force to the front roller and at the same time revolves the wheel of the parked car. If the moment of external forces exerting on the wheel of the parked car is larger than the maximum static friction moment between the axis and the bearing of the parked car, the wheel of the parked car rotates and the car moves.

Although one push car cannot generate enough power to move a parked car, more than two push cars can generate enough power to move a parked car. Although one push car cannot generate enough power to move a parked car, it can play a role to help a pusher.

A parked car tends to have lowest potential energy. For this reason there are frequent occasions which the car is moved small distance by power of a pusher but immediately it returns to original location. In this case if he applies the push car behind the wheel of the car, after the car is moved small distance by power of a pusher, it cannot returns to original location due to the push car. Consequently he can move the car more easily.

### MODE FOR THE INVENTION

In above example of execution rotational power is transmitted from power source (26) to decelerator (25), from decelerator (25) to upper roller (23), and from upper roller (23) to front roller (21). But this transmission oder may be changeable. Namely, rotational power may be transmitted from decelerator (25) to front roller (21) without passing upper roller (23) and from decelerator (25) to rear roller (28) as well as front roller (21). But, in any case, upper roller (23) must revolve opposite direction against front roller (21). And rear roller (28) revolve same direction to front roller (21)

### INDUSTRIAL APPLICABILITY

The present invention can be manufactured easily and useful.

1. A push car characterized by comprising:
at least one front roller which revolves on its centroidal axis and comes in contact with earth surface;
at least one upper roller which revolves on its centroidal axis parallel to and being apart from the rotation axis of the front roller and which is out of contact with earth surface;
at least one decelerator which amplifies rotating force from power source;
at least one power source which generates rotating power; and
a housing which supports the rotation axes of the front roller and the upper roller.

2. A push car as recited in claim 1, wherein a part of the upper roller is characterized by protruding outside of the housing.

3. A push car as recited in claim 2, wherein the rotational direction of the front roller is opposite direction to that of the upper roller and the absolute value of angular velocity times radius of the front roller is equal to that of the upper roller.

4. A push car as recited in claim 2, or claim 3, further including a controller to supply or to cut off electricity to power source or to change the direction of rotational direction of the front roller and the upper roller.

5. A push car as recited in claim 4, wherein the controller includes a receiver receiving signal from outside remote controller.
